(19) United States
(12) Patent Application Publication
(10) Pub. No.: US 2016/0125503 A1
(43) Pub. Date: May 5, 2016

(54) METHOD, APPARATUS AND SYSTEM FOR RECOMMENDING PRODUCT INFORMATION

(71) Applicant: BEIJING JINGDONG SHANGKE INFORMATION TECHNOLOGY CO., LTD, Beijing (CN)

(72) Inventors: Jian Li, Shenzhen City (CN); Gang Cheng, Shenzhen City (CN)

(21) Appl. No.: 14/896,285

(22) PCT Filed: Dec. 27, 2013
(86) PCT No.: PCT/CN2013/090662

§ 371 Date: Dec. 4, 2015

(30) Foreign Application Priority Data
Jun. 5, 2013 (CN) 201310222166.3

(51) Int. Cl. G06Q 30/06

(52) U.S. Cl. CPC G06Q 30/0631

(57) ABSTRACT

A method, an apparatus and a system for recommending product information is provided. The system acquires a product list comprising product information, such as product name and price indexes, on at least one product; sets product labels for the product information in the product list according to the product names; calculates a purchasing power index of a user and acquires personalized labels of the user; and, then generates a personalized product recommendation list for the user according to the purchasing power index, the personalized labels, the product labels, and the price indexes. Finally, the system can make a recommendation to the user based on the product recommendation list.

### CROSS-REFERENCE TO RELATED APPLICATION(S)

This application is a U.S. national phase application of PCT Application No. PCT/CN2013/090662, filed on Dec. 27, 2013, entitled “METHOD, APPARATUS AND SYSTEM FOR RECOMMENDING PRODUCT INFORMATION,” which claims priority to Chinese Application No. 201310222166.3, filed on Jun. 5, 2013. Both the PCT Application and the Chinese Application are incorporated herein by reference in their entireties.

### TECHNICAL FIELD

The present disclosure relates to the field of communication technology, and in particular, to information recommendation.

### BACKGROUND

With development of network communications, people's lives and behavior styles also gradually change. Shopping online, also called online shopping, is a great revolution for conventional transactions, and is gradually preferred by people due to its features such as a low transaction cost, a simple operation, and high efficiency etc. During online shopping, it is gradually a problem concerned by people about how to accurately recommend production information to a suitable user so that the user can more conveniently obtain his/her required and interested product information from crowded information, so as to save search time for the user, improve user experience, and enhance efficiency in information processing.

The existing methods for recommending products cannot accurately recommend product information to a user with corresponding requirements.

### SUMMARY

Embodiments of the present disclosure provide a method, an apparatus and a system for recommending product information, which can recommend product information to a user with corresponding requirements.

The embodiments of the present disclosure provide a method of recommending product information, comprising: acquiring a product list comprising product information on at least one product, wherein the product information comprises product names and price indexes and is associated with at least one product label; calculating a purchasing power index of a user and acquiring personalized labels of the user, wherein the personalized labels are a set of product labels that the user likes; generating a product recommendation list for the user according to the purchasing power index, the personalized labels, the product labels, and the price indexes, wherein product information in the product recommendation list is selected from the product list; and making a recommendation to the user based on the product recommendation list.

Correspondingly, the present disclosure provides an apparatus for recommending product information, comprising: a product information acquisition unit, configured to acquire a product list comprising product information on at least one product from a server, wherein the product information comprises product names and price indexes and is associated with at least one product label; a user information collection unit, configured to calculate a purchasing power index of a user and acquire personalized labels of the user, wherein the personalized labels are a set of product labels that the user likes; a product recommendation list generation unit, configured to generate a product recommendation list for the user according to the purchasing power index, the personalized labels, the product labels, and the price indexes, wherein product information in the product recommendation list is selected from the product list; and a recommendation unit, configured to make a recommendation to the user based on the product recommendation list.

Correspondingly, the embodiments of the present disclosure further provide a communication system, comprising: a server; and the apparatus for recommending product information according to any of the embodiments of the present disclosure.

The embodiments of the present disclosure can acquire a product list comprising product information of at least one product, wherein the product information comprises product names and price indexes; set product labels for the product information in the product list according to the product names; calculate a purchasing power index of a user and acquire personalized labels of the user; then generate a personalized product recommendation list for the user according to the purchasing power index, the personalized labels, the product labels, and the price indexes; and make a recommendation to the user based on the product recommendation list. This solution can not only accurately recommend the product information to the user with corresponding requirements, but also better comply with users' requirements as the product recommendation list is generated according to the purchasing power and hobbies and interests of the user, thereby improving quality of the user's experience.

### BRIEF DESCRIPTION OF THE DRAWINGS

For better understanding the technical solutions in the embodiments of the present disclosure or the related art, accompanying drawings which are required to be used in the embodiments or the related art will be described below in brief.

FIG. 1 is a flowchart of a method of recommending product information according to an embodiment of the present disclosure;

FIG. 2 is a flowchart of a method of recommending product information according to another embodiment of the present disclosure;

FIG. 3 is a flowchart of a method of recommending product information according to a yet another embodiment of the present disclosure;

FIG. 4 is a structure diagram of an apparatus for recommending product information according to an embodiment of the present disclosure; and

FIG. 5 is a structure diagram of a server according to an embodiment of the present disclosure.

### DETAILED DESCRIPTION

The technical solutions in the embodiments of the present disclosure will be described clearly and completely below in conjunction with accompanying drawings in the embodiments of the present disclosure. Obviously, the embodiments described below are merely some embodiments of the present disclosure instead of all the embodiments. All other embodiments obtained by those skilled persons in the art based on the embodiments of the present disclosure without any creative labor belong to the protection scope of the present disclosure.

The embodiments of the present disclosure provide a method, an apparatus and a system for recommending product information, which will be respectively described in detail below.

### First Embodiment

The present embodiment will be described from a perspective of an apparatus for recommending product information, and the apparatus for recommending product information may be integrated into a server.

A method of recommending product information comprises: acquiring a product list comprising product information of at least one product from a server, wherein the product information comprises product names and price indexes, and is associated with at least one product label; calculating a purchasing power index of a user and acquiring personalized labels of the user, wherein the personalized labels are a set of product labels that the user likes; generating a product recommendation list for the user according to the purchasing power index, the personalized labels, the product labels, and the price indexes, wherein product information in the product recommendation list is selected from the product list; and making a recommendation to the user based on the product recommendation list.

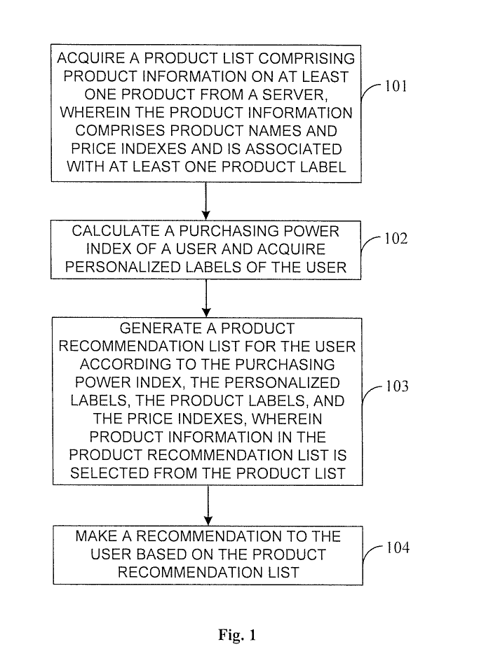

As shown in FIG. 1, a particular process may be as follows.

In step 101, a product list comprising product information of at least one product is acquired from a server, wherein the product information comprises product names and price indexes etc., and the product information is associated with at least one product label.

Of course, the product information may also comprise other information. For example, the product information may also comprise recommendation scores etc.

As used herein, the term “product label” refers to an attribute of a product. Attribute values of the product labels may be set according to requirements in practical applications. For example, the product labels may comprise “fashion”, “metallic feeling”, “health” and/or “leather” etc.

It should be illustrated that the labels in the embodiment of the present disclosure are not equivalent to classification of goods, but are positioning attributes of goods, for example, appeals such as fashion, popularity, reminiscence, and literature etc., and description such as metallic feeling, import, and protection of place of origin etc.

It should be illustrated that in the embodiment of the present disclosure, the price index of a product reflects how many products with the same type as that of the product which have been sold have prices lower than that of the product among the products of the same type having been sold. For example, if there are 700 products with the same type as that of the product which have been sold at prices lower than that of the product among 1000 products with the same type which have been sold, the price index of the product is 0.7.

Since the prices of most of the products may be concentrated within a smaller interval, a logical distribution formula may be used for balancing in order to balance distribution of data. That is, after the product list is acquired (i.e., step 101), the method may further comprise:

performing a balance processing on the price indexes using the logical distribution formula to obtain balanced price indexes. For example, the calculation formula may be as follows.

$$price ( i ) \_dis = \frac{price ( i ) - u ( price )}{σ ( price )}$$

wherein, price(i)_dis is a balanced price index, u(price) is an average value of the price indexes, and σ(price) is a variance of the price indexes.

In step 102, a purchasing power index of a user is calculated and personalized labels of the user are acquired.

wherein, the personalized labels are a set of product labels that the user likes. For example, if a user likes a product with the product labels such as “fashion” and “metallic feeling” etc., the personalized labels of the user are “fashion” and “metallic feeling”. The personalized labels may be selected and set by the user himself/herself; or the system may perform a statistic and analysis process according to historical purchasing and browsing records of the user, and then set the personalized labels for the user according to the analysis result, which will not be described here in detail.

The purchasing power described in the embodiment of the present disclosure refers to a position of the price of the product which is purchased by the user in the prices of the products with the same type. The purchasing power index is a value which may reflect the purchasing power of the user. The purchasing power index of the user may be measured by the price indexes of the products purchased by the user. For example, the purchasing power index of the user may be calculated according to price indexes and weights of respective types of products which have been purchased by the user. In particular,

The price indexes and the weights of the respective types of products which have been purchased by the user are acquired. Products of the price indexes and the weights of the respective types of products which have been purchased by the user are summed to obtain a first value. The first value is divided by a sum of the weights of the respective types of products which have been purchased by the user to obtain the purchasing power index of the user. The formula is as follows.

$$purchasing\_power = \frac{{\sum }_{i = 1}^{n} weight ( i ) * price ( i )}{{\sum }_{i = 1}^{n} weight ( i )}$$

wherein purchasing_power is the purchasing power index of the user, Weight(i) is a weight of an i-th type of products, and price(i) is a price index of the i-th type of products.

For example, by taking a user purchasing a product “towel” as an example, the purchasing power index of the user for this type of products may be calculated as follows.

A price interval of the towels is from RMB 5 to RMB 100, and a towel is purchased by the user at a price of RMB 20. In the past time period, 85% of all the towels which have been sold are sold at prices lower than the price of RMB 20. In this case, the purchasing power index of the user for the type of products is 0.85.

It should be illustrated that when the user only purchases one type of product, the weight of the respective types of products which have been purchased by the user is 1. In this case, the purchasing power index of the user is equal to the price index of the product purchased by the user.

In step 103, a product recommendation list for the user is generated according to the purchasing power index and the personalized labels obtained in step 102 as well as the product labels and the price indexes of respective product information in the product list.

For example, specifically, products which comply with a consumptive level of the user may firstly be filtered out according to the purchasing power index of the user, and then the product recommendation list for the user is calculated and obtained according to the personalized labels of the user. Alternatively, products which comply with preferences of the user may firstly be calculated and obtained according to the personalized labels of the user; and then the products which comply with the consumptive level of the user are filtered out from the products which comply with the preferences of the user, according to the purchasing power index of the user, so as to obtain the product recommendation list for the user. That is, for example, any of the following manners may particularly be used to generate the product recommendation list for the user.

First Manner:

(1) filtering the product information in the product list according to the purchasing power index and the price indexes to obtain a set. For convenience of description, the set is referred to as a first set of results in the embodiment of the present disclosure. For example, the process may particularly comprise:

comparing the purchasing power index with the price indexes of the product information in the product list respectively; and if an absolute value of a difference between the purchasing power index and the price index is less than a first predetermined threshold, adding corresponding product information to the first set of results.

The first predetermined threshold may be set according to requirements in practical applications, and will not be described here in detail.

(2) filtering the first set of results according to the personalized labels and the product labels to obtain a set. For convenience of description, the set is referred to as a second set of results in the embodiment of the present disclosure. For example, the process may particularly comprise:

respectively calculating liking probabilities of the user on respective product labels according to the personalized labels; calculating liking probabilities of the user on respective product information in the first set of results according to the liking probabilities of the user on the respective product labels; calculating user liking degree scores of respective product information in the first set of results according to the liking probabilities and the recommendation scores (which are included in the product information) of the user for the respective product information in the first set of results; and adding the product information of which the user liking degree score exceeds a second predetermined threshold to the second set of results.

The second predetermined threshold may be set according to requirements in practical applications, and will not be described here in detail.

(3) generating the product recommendation list for the user according to the second set of results. For example, the process may particularly comprise:

ranking the product information in the second set of results according to the user liking degree scores to generate the product recommendation list for the user.

Second Manner:

(1) filtering the product information in the product list according to the personalized labels and the product labels to obtain a set. For convenience of description, the set is referred to as a third set of results in the embodiment of the present disclosure. For example, the process may particularly comprise:

respectively calculating liking probabilities of the user on respective product labels according to the personalized labels; calculating liking probabilities of the user on respective product information in the product list according to the liking probabilities of the user on the respective product labels; calculating user liking degree scores of respective product information in the product list according to the liking probabilities and the recommendation scores (which are included in the product information) of the user for the respective product information in the product list; and adding the product information of which the user liking degree score exceeds a second predetermined threshold to the third set of results.

The second predetermined threshold may be set according to requirements in practical applications, and will not be described here in detail.

(2) filtering the third set of results according to the purchasing power index and the price indexes to obtain a set. For convenience of description, the set is referred to as a fourth set of results in the embodiment of the present disclosure. For example, the process may particularly comprise:

comparing the purchasing power index with the price indexes of the product information in the third set of results respectively; and if an absolute value of a difference between the purchasing power index and the price index is less than a first predetermined threshold, adding corresponding product information into the fourth set of results.

The first predetermined threshold may be set according to requirements in practical applications, and will not be described here in detail.

(3) generating the product recommendation list for the user according to the fourth set of results. For example, the process may particularly comprise:

ranking the product information in the fourth set of results according to the user liking degree scores to generate the product recommendation list for the user.

It should be illustrated that if the balance processing has been performed on the price indexes using a logical distribution formula in step 101, the price indexes used in this step may be balanced price indexes, i.e., step 103 may particularly comprise:

generating the product recommendation list for the user according to the purchasing power index, the personalized labels, the product labels, and the balanced price indexes.

In step 104, a recommendation is made to the user based on the product recommendation list.

Thus, the present embodiment may acquire a product list comprising product information of at least one product, wherein the product information comprises product names and price indexes and is associated with at least one product label; calculate a purchasing power index of the user and acquire personalized labels of the user; generate a personalized product recommendation list for the user according to the purchasing power index, the personalized labels, the product labels, and the price indexes; and make a recommendation to the user based on the product recommendation list. This solution can not only accurately recommend the product information to a user with corresponding requirements, but also better comply with users' requirements as the product recommendation list is generated according to the purchasing power and hobbies and interests of the user, thereby improving quality of the user's experience.

### Second Embodiment

The method according to the second embodiment will be described in detail below by way of example.

The present embodiment will be described by taking the following process as an example, i.e., firstly filtering out products which comply with the consumptive level of the user according to the purchasing power index of the user, and then calculating and obtaining the product recommendation list for the user according to the personalized labels of the user.

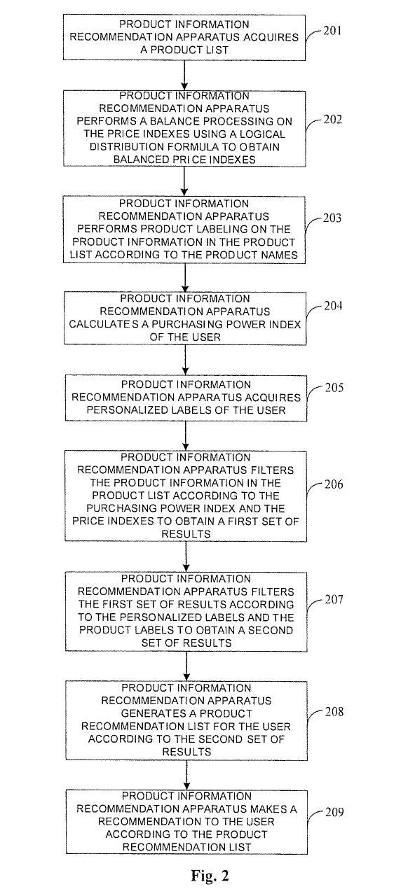

As shown in FIG. 2, a particular process of a method of recommending product information may be as follows.

In step 201, a product information recommendation apparatus acquires a product list from a server.

The product list may be predetermined, or may be automatically generated by the system. For example, the product list may particularly be a popular product recommendation list, and the popular product recommendation list may be generated by performing comprehensive calculation using parameters including product sales volume, user evaluation scores and/or profits etc. There may be multiple arrangement forms of the product information in the popular product recommendation list. For example, the product information may be ranked according to the product sales volume, the user evaluation scores, the recommendation scores, or the degrees of discount etc. For convenience of description, the embodiment of the present disclosure will be described by taking the following process as an example, i.e., ranking the product information in the product list in an order of the recommendation scores from high to low. That is, the product information with a high recommendation score is preferentially recommended. In an example, by taking a data format (product name, price index, recommendation index) of the product information in the product list as an example, the product list may particularly be as follows.

{ . . . ,(Product B, 0.85, 2000), (product C, 0.36, 1500), (Product A, 0.82, 1000), . . . }.

It should be illustrated that since prices of most of the products may be concentrated in a small interval, a logical distribution formula may be used for balancing in order to balance data distribution. That is, after the product list is acquired, step 202 may further be performed.

In step 202, the product information recommendation apparatus performs a balance processing on the price indexes of respective product information in the product list using the logical distribution formula to obtain balanced price indexes. For example, a particular calculation formula may be as follows.

$$price ( i ) \_dis = \frac{price ( i ) - u ( price )}{σ ( price )}$$

wherein price(i)_dis is a balanced price index, u(price) is an average value of the price indexes, and σ(price) is a variance of the price indexes.

In step 203, the product information recommendation apparatus performs product labeling on the product information in the product list according to the product names, i.e., setting product labels. Product labels may be set for the products in a manner such as manual markup, data mining etc., which will not be described here in detail.

Attribute values of the product labels may be set according to requirements in practical applications. For example, the product labels may comprise labels such as “fashion”, “metallic feeling”, “health” and/or “leather” etc.

In step 204, the product information recommendation apparatus acquires price indexes and weights of respective types of products which have been purchased by the user, sums products of the price indexes and the weights of the respective types of products which have been purchased by the user to obtain a first value, and divides the first value by a sum of the weights of respective types of products which have been purchased by the user to obtain the purchasing power index of the user. The formula is as follows.

$$purchasing\_power = \frac{{\sum }_{i = 1}^{n} weight ( i ) * price ( i )}{{\sum }_{i = 1}^{n} weight ( i )}$$

wherein purchasing_power is the purchasing power index of the user, Weight(i) is a weight of an i-th type of products, and price(i) is a price index of the i-th type of products.

For example, by taking a user purchasing a product “towel” as an example, the purchasing power index of the user for this type of products may be calculated as follows.

A price interval of the towels is from RMB 5 to RMB 100, and a towel is purchased by the user at a price of RMB 20. In the past time period, 85% of all the towels which have been sold are at a price lower than the price of RMB 20. In this case, the purchasing power index of the user for the type of products is 0.85.

It should be illustrated that when the user only purchases one type of product, the weight of the respective types of products which have been purchased by the user is 1. In this case, the purchasing power index of the user is equal to the price index of the product purchased by the user.

In step 205, the product information recommendation apparatus acquires personalized labels of the user.

The personalized labels are a set of product labels that the user likes. For example, if a user likes a product with the product labels such as “fashion” and “metallic feeling” etc., the personalized labels of the user are “fashion” and “metallic feeling”. The personalized labels may be selected and set by the user himself/herself; or the system may perform a statistic and analysis process according to historical purchasing and browsing records of the user, and then set the personalized labels for the user according to the analysis result. For example, if the set of labels of products which are purchased by the user is {fashion, popular, metallic feeling, . . . } etc., the set of labels may be used as personalized labels of the user. For example, in particular,

If the products that User A likes are shown in table one, a corresponding set of labels is {health, fashion, metallic feeling, petty bourgeoisie, fashion, fashion, metallic feeling, petty bourgeoisie, myth, petty bourgeoisie}

TABLE ONE

| Product name | Product label 1 | Product label 2 | Product label 3 |
|---|---|---|---|
| olive oil | health | | |
| Iphone | fashion | metallic feeling | petty bourgeoisie |
| Coach | fashion | | |
| Ipad | fashion | metallic feeling | petty bourgeoisie |
| Chanel No. 5 | sexy | petty bourgeoisie | |

Steps 204 and 205 may be performed in a random order.

In step 206, the product information recommendation apparatus filters the product information in the product list according to the purchasing power index and the price indexes to obtain a first set of results. For example, the process may particularly comprise:

comparing the purchasing power index with the price indexes of the product information in the product list respectively; and if an absolute value of a difference between the purchasing power index and the price index is less than a first predetermined threshold, adding corresponding product information to the first set of results. This may be formulated as follows.

|purchasing_power−price(i)|<τ

wherein τ is a first predetermined threshold, and is a constant threshold. The particular value of τ may be set according to requirements in practical application. For example, a value range of τ may be set as (0,1). “purchasing_power” is a purchasing power index, and “price(i)” is a price index of an i-th type of products. Of course, if the price indexes have been balanced in step 202, the balanced price indexes, i.e., price(i)_dis, may be used as the price indexes here.

In step 207, the product information recommendation apparatus filters the first set of results according to the personalized labels and the product labels to obtain a second set of results. For example, the process may particularly comprise:

respectively calculating liking probabilities of the user on respective product labels according to the personalized labels; calculating liking probabilities of the user on respective product information in the first set of results according to the liking probabilities of the user on the respective product labels; calculating user liking degree scores of respective product information in the first set of results according to the liking probabilities and the recommendation scores (which are included in the product information) of the user for the respective product information in the first set of results; and adding the product information of which the user liking degree score exceeds a second predetermined threshold to the second set of results.

(1) Calculating liking probabilities of the user on the respective product labels;

wherein the liking probabilities of the user on the respective product labels may be calculated according to probabilities that the user liked the respective product labels and probabilities that the user did not like the respective product labels in a historical recommendation record. The particular process may be as follows.

For example, assuming that a product is recommended to User A, the probability that the user likes the product and the probability that the user does not like the product are 50% respectively if no any other factors are considered, i.e., P(like)=P(not like)=50%.

It can be known from the example in step 206 that there are five products in total that User A likes, in which there are three products having the product label of “fashion”, there are two products having the product label of “metallic feeling”, and there is one product having the product label of “health”. In this case,

the probability that the products User A likes have the product label of “fashion” is P(fashion/like)=3/5=0.6;

the probability that the products User A likes have the product label of “metallic feeling” is P(metallic feeling/like)=2/5=0.4; and

the probability that the products User A likes have the product label of “health” is P(health/like)=1/5=0.2.

Assuming that there are in history ten products which are recommended to User A but are not liked by User A, in which there are two products having the product label of “fashion”, there are three products having the product label of “metallic feeling”, and there are three products having the product label of “health”. In this case,

the probability that the products User A likes have the product label of “fashion” is P(fashion/not like)=2/10=0.2;

the probability that the products not liked by User A have the product label of “metallic feeling” is P(metallic feeling/not like)=3/10=0.3; and

the probability that the products not liked by User A have the product label of “health” is P(health/not like)=3/10=0.3.

It can be known from Bayes formula that:

the probability that User A likes a product having a product label of “fashion” among the products is P(like/fashion)=P(fashion/like)/(P(fashion/like)+P(fashion/not like))=0.6/(0.6+0.2)=0.75;

the probability that User A likes a product having a product label of “metallic feeling” among the products is P(like/metallic feeling)=P(metallic feeling/like)/(P(metallic feeling/like)+P(metallic feeling/not like))=0.4/(0.4+0.2)=0.67;

the probability that User A likes a product having a product label of “health” among the products is P (like/health)=P(health/like)/(P(health/like)+P(health/not like))=0.2/(0.2+0.3)=0.4;

That is, the probabilities that the user likes the respective product labels are respectively as follows: P(like/fashion) is 0.75, P(like/metallic feeling) is 0.67, and P(like/health) is 0.4.

(2) Calculating liking probabilities and disliking probabilities of the user on a combination of the product labels;

since the liking probabilities of the user on the respective product labels are respectively as follows: P(like/fashion) is 0.75, P(like/metallic feeling) is 0.67, and P(like/health) is 0.4, the liking probabilities of the user on a product having the following combinations of product labels among the products are respectively as follows:

P(like/fashion, metallic feeling)=P(like/fashion)*P(like/metallic feeling)*P(like)=0.75*0.67*0.5=0.25;

P(like/health, fashion)=P(like/health)*P(like/fashion)*P(like)=0.4*0.75*0.5=0.15.

On the contrary, the disliking probabilities of the user on a product having the following combination of product labels (a product may have multiple product labels) among the products are respectively as follows:

P(not like/fashion, metallic feeling)=(1−P(like/fashion))*(1−P(like/metallic feeling))*P(not like)=0.25*0.33*0.5=0.04;

P(not like/health, fashion)=(1−P(like/health))*(1−P(like/fashion))*P(not like)=0.6*0.25*0.5=0.075.

(3) Calculating liking probabilities of the user on the product information;

It can be known from the above calculation that if there is any product having the product labels of “fashion” and “metallic feeling”, the probability that the product is liked by User A (i.e., the liking probability of the user on the product information) is:

P(s1)=P(like/fashion, metallic feeling)/(P(like/fashion, metallic feeling)+P(not like/fashion, metallic feeling))=0.25/(0.25+0.04)=0.86;

if there is any product having the product labels of “health” and “fashion”, the probability that the product is liked by User A (i.e., the liking probability of the user on the product information) is:

P(s2)=P(like/health, fashion)/(P(like/health, fashion)+P(not like/health, fashion))=0.15/(0.15+0.075)=0.67.

(4) Calculating user liking degree scores of the product information;

After the liking probabilities of the user on the product information are calculated, the user liking degree scores of the product information may be calculated according to the liking probabilities and the recommendation scores (which are included in the product information), wherein the calculation formula for the liking degree score is as follows:

L_score=score*P(s)

wherein “L_score” is a user liking degree score, “score” is a recommendation score; P(S) is a probability that the user likes the product (having product label(s)) (i.e., a liking probability of the user on a combination of the product labels in the product).

For example, assuming that the first set of results comprises Product A and Product B, wherein the product labels of Product A are “fashion” and “metallic feeling”, and the recommendation score of Product A is 1000, and the product labels of Product B are “health” and “fashion”, and the recommendation score of Product B is 2000, the user liking degree scores for Product A and Product B are respectively as follows.

L_score(Product A)=1000*P(like|fashion, metallic feeling)=1000*0.86=860; and

L_score(Product B)=2000*P(like|health, fashion)=2000*0.67=1340.

(5) Adding product information of which the user liking degree score exceeds a second predetermined threshold to the second set of results.

After the user liking degree scores of the respective product information are obtained, it may be determined whether each of these user liking degree scores exceeds the second predetermined threshold; if so, the corresponding product information is added to the second set of results; otherwise, no action may be performed or the corresponding product information may be discarded.

In step 208, the product information recommendation apparatus generates the product recommendation list for the user according to the second set of results. For example, the process may particularly comprise:

ranking the product information in the second set of results according to the user liking degree scores (for example, from high to low or from low to high, and preferably, from high to low) to generate the product recommendation list for the user. For example, since 1340 (the user liking degree score of Product B) is larger than 860 (the user liking degree score of Product A), Product B is recommended to the user in preference to Product A when a recommendation is made to the user.

In step 209, the product information recommendation apparatus makes a recommendation to the user based on the product recommendation list.

Thus, the present embodiment may acquire a product list comprising product information of at least one product, wherein the product information comprises product names and price indexes; set product labels for the product information in the product list according to the product names; calculate a purchasing power index of the user and acquire personalized labels of the user; then filter out products which comply with a consumptive level of the user according to the purchasing power index of the user; calculate and obtain a personalized product recommendation list for the user according to the personalized labels of the user; and make a recommendation to the user based on the product recommendation list. This solution can not only accurately recommend the product information to a user with corresponding requirements, but also better comply with users' requirements as the product recommendation list is generated according to the purchasing power and hobbies and interests of the user, thereby improving quality of the user's experience.

### Third Embodiment

Different from the second embodiment, the present embodiment will be described by taking the following process as an example, i.e., firstly calculating and obtaining products in which a user is interested according to the personalized labels of the user, then filtering out products which comply with a consumptive level of the user according to the purchasing power index of the user, and obtaining the product recommendation list for the user.

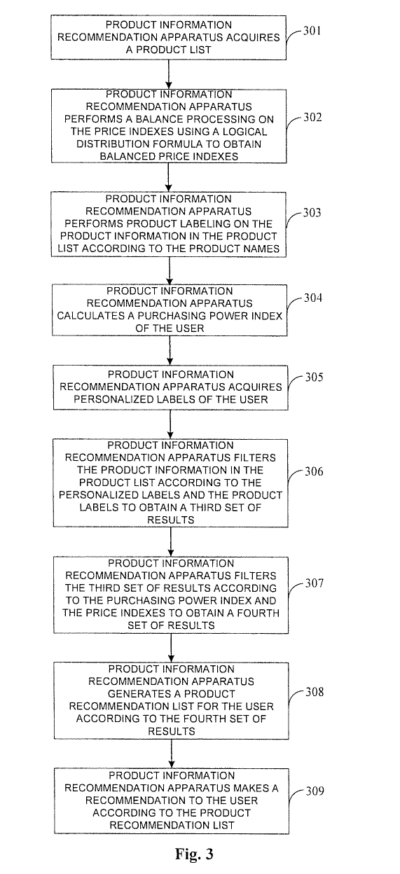

As shown in FIG. 3, a particular process of a method of recommending product information may comprise:

In step 301, a product information recommendation apparatus acquires a product list from a server.

The product list may be predetermined, or may be automatically generated by the system. For example, the product list may particularly be a popular product recommendation list, and the popular product recommendation list may be generated by performing comprehensive calculation using parameters including product sales volume, user evaluation scores and/or profits etc. There may be multiple arrangement forms of the product information in the popular product recommendation list. For example, the product information may be ranked according to the product sales volume, the user evaluation scores, the recommendation scores, or the degrees of discount etc. For convenience of description, the embodiment of the present disclosure will be described by taking the following process as an example, i.e., ranking the product information in the product list in an order of the recommendation scores from high to low. That is, the product information with a high recommendation score is preferentially recommended. In an example, by taking a data format (product name, price index, recommendation index) of the product information in the product list as an example, the product list may particularly be as follows.

{ . . . ,(Product B, 0.85, 2000), (product C, 0.36, 1500), (Product A, 0.82, 1000), . . . }

It should be illustrated that since prices of most of the products may be concentrated in a small interval, a logical distribution formula may be used for balancing in order to balance data distribution. That is, after the product list is acquired, step 302 may further be performed.

In step 302, the product information recommendation apparatus performs a balance processing on the price indexes of respective product information in the product list using the logical distribution formula to obtain balanced price indexes. For example, a particular calculation formula may be as follows.

$$price ( i ) \_dis = \frac{price ( i ) - u ( price )}{σ ( price )}$$

wherein price(i)_dis is a balanced price index, u(price) is an average value of the price indexes, and σ(price) is a variance of the price indexes.

In step 303, the product information recommendation apparatus performs product labeling on the product information in the product list according to the product names, i.e., setting product labels. Product labels may be set for the products in a manner such as manual markup, data mining etc., which will not be described here in detail.

Attribute values of the product labels may be set according to requirements in practical applications. For example, the product labels may comprise labels such as “fashion”, “metallic feeling”, “health” and/or “leather” etc.

In step 304, the product information recommendation apparatus acquires price indexes and weights of respective types of products which have been purchased by the user, sums products of the price indexes and the weights of the respective types of products which have been purchased by the user to obtain a first value, and divides the first value by a sum of the weights of respective types of products which have been purchased by the user to obtain the purchasing power index of the user. The formula is as follows.

$$purchasing\_power = \frac{{\sum }_{i = 1}^{n} weight ( i ) * price ( i )}{{\sum }_{i = 1}^{n} weight ( i )}$$

wherein purchasing_power is the purchasing power index of the user, Weight(i) is a weight of an i-th type of products, and price(i) is a price index of the i-th type of products.

For example, by taking a user purchasing a product “towel” as an example, the purchasing power index of the user for this type of products may be calculated as follows.

A price interval of the towels is from RMB 5 to RMB 100, and a towel is purchased by the user at a price of RMB 20. In the past time period, 85% of all the towels which have been sold are at a price lower than the price of RMB 20. In this case, the purchasing power index of the user for the type of products is 0.85.

It should be illustrated that when the user only purchases one type of product, the weight of the respective types of products which have been purchased by the user is 1. In this case, the purchasing power index of the user is equal to the price index of the product purchased by the user.

In step 305, the product information recommendation apparatus acquires personalized labels of the user.

The personalized labels are a set of product labels that the user likes. For example, if a user likes a product with the product labels such as “fashion” and “metallic feeling” etc., the personalized labels of the user are “fashion” and “metallic feeling”. The personalized labels may be selected and set by the user himself/herself; or the system may perform a statistic and analysis process according to historical purchasing and browsing records of the user, and then set the personalized labels for the user according to the analysis result. For example, if the set of labels of products which are purchased by the user is {fashion, popular, metallic feeling, . . . } etc., the set of labels may be used as personalized labels of the user. For example, in particular,

If the products that User A likes are shown in table one, a corresponding set of labels is {health, fashion, metallic feeling, petty bourgeoisie, fashion, fashion, metallic feeling, petty bourgeoisie, myth, petty bourgeoisie}

TABLE ONE

| Product name | Product label 1 | Product label 2 | Product label 3 |
|---|---|---|---|
| olive oil | health | | |
| Iphone | fashion | metallic feeling | petty bourgeoisie |
| Coach | fashion | | |
| Ipad | fashion | metallic feeling | petty bourgeoisie |
| Chanel No. 5 | sexy | petty bourgeoisie | |

Steps 304 and 305 may be performed in a random order.

In step 306, the product information recommendation apparatus filters the product information in the product list according to the personalized labels and the product labels to obtain a third set of results. For example, the process may particularly comprise:

respectively calculating liking probabilities of the user on respective product labels according to the personalized labels; calculating liking probabilities of the user on respective product information in the product list according to the liking probabilities of the user on the respective product labels; calculating user liking degree scores of the product information in the product list according to the liking probabilities and the recommendation scores (which are included in the product information) of the user for the respective product information in the product list; and adding the product information of which the user liking degree score exceeds a second predetermined threshold to the third set of results. The particular implementation is the same as that of step 207 in the second embodiment. For example, the particular process may comprise:

(1) calculating liking probabilities of the user on the respective product labels;

(2) calculating liking probabilities and disliking probabilities of the user on a combination of the product labels;

(3) calculating liking probabilities of the user on the product information;

(4) calculating user liking degree scores of the product information;

(5) adding product information of which the user liking degree score exceeds a second predetermined threshold to the second set of results.

The particular implementation may refer to step 207 in the second embodiment, and will not be described here in detail.

In step 307, the product information recommendation apparatus filters the third set of results according to the purchasing power index and the price indexes to obtain a fourth set of results. For example, the particular process may comprise:

comparing the purchasing power index with the price indexes of the product information in the third set of results respectively; and if an absolute value of a difference between the purchasing power index and the price index is less than a first predetermined threshold, adding corresponding product information to the fourth set of results. This may be formulated as follows.

|purchasing_power−price(i)|<τ

wherein τ is a first predetermined threshold, and is a constant threshold. The particular value of τ may be set according to requirements in practical application. For example, a value range of τ may be set as (0,1). “purchasing_power” is a purchasing power index, and “price(i)” is a price index of an i-th type of products. Of course, if the price indexes have been balanced in step 302, the balanced price indexes, i.e. price(i)_dis, may be used as the price indexes here.

In step 308, the product information recommendation apparatus generates the product recommendation list for the user according to the fourth set of results. For example, the process may particularly comprise:

ranking the product information in the second set of results according to the user liking degree scores (for example, from high to low or from low to high, and preferably, from high to low) to generate the product recommendation list for the user.

In step 309, the product information recommendation apparatus makes a recommendation to the user based on the product recommendation list.

Thus, the present embodiment may acquire a product list comprising product information of at least one product, wherein the product information comprises product names and price indexes; set product labels for the product information in the product list according to the product names; calculate a purchasing power index of the user and acquire personalized labels of the user; calculate and obtain the products that the user likes according to the personalized labels of the user; then filter out products which comply with a consumptive level of the user according to the purchasing power index of the user, and obtain a personalized product recommendation list for the user; and make a recommendation to the user based on the product recommendation list. This solution can not only accurately recommend the product information to a user with corresponding requirements, but also better comply with users' requirements as the product recommendation list is generated according to the purchasing power and hobbies and interests of the user, thereby improving quality of the user's experience.

### Fourth Embodiment

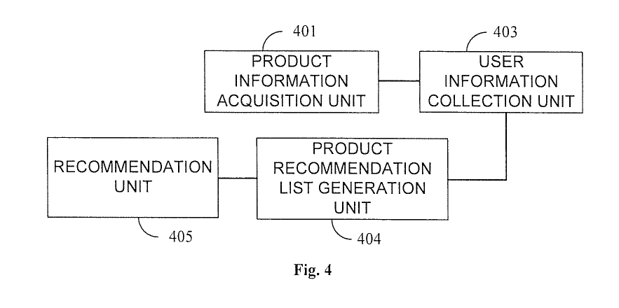

For better performing the above method, the embodiment of the present disclosure further provides an apparatus for recommending product information. As shown in FIG. 4, the apparatus for recommending product information comprises a product information acquisition unit 401, a user information collection unit 403, a product recommendation list generation unit 404 and a recommendation unit 405.

The product information acquisition unit 401 is configured to acquire a product list from a server.

The product list comprises product information of at least one product, wherein the product information comprises product names and price indexes etc., and the product information is associated with at least one product label. Of course, the product information may also comprise other information. For example, the product information may further comprise recommendation scores etc.

Attribute values of the product labels may be set according to requirements in practical applications. For example, the product labels may comprise “fashion”, “metallic feeling”, “health” and/or “leather” etc.

The user information collection unit 403 is configured to calculate a purchasing power index of a user and acquire personalized labels of the user.

wherein the personalized labels are a set of product labels that the user likes. For example, if a user likes a product with product labels such as “fashion” and “metallic feeling” etc., the personalized labels of the user are “fashion” and “metallic feeling”. The personalized labels may be selected and set by the user himself/herself, or a statistic and analysis process may be implemented by a system according to historical purchasing and browsing records of the user, and the personalized labels are set for the user according to an analysis result, which will not be described here in detail.

The product recommendation list generation unit 404 is configured to generate a product recommendation list for the user according to the purchasing power index, the personalized labels, the product labels, and the price indexes.

The recommendation unit 405 is configured to make a recommendation to the user based on the product recommendation list.

Alternatively, the product recommendation list generation unit 404 may particularly be configured to firstly filter out the products which comply with a consumptive level of the user according to the purchasing power index of the user, and then calculate and obtain the product recommendation list for the user according to the personalized labels of the user. Or, the product recommendation list generation unit 404 may also be configured to firstly calculate and obtain the products which comply with preferences of the user according to the personalized labels of the user, and then filter out the products which comply with the consumptive level of the user from the products which comply with the preferences of the user according to the purchasing power index of the user, to obtain the product recommendation list for the user. That is, the product recommendation list generation unit 404 may particularly generate the product recommendation list for the user in any of the following manners:

First Manner: the product recommendation list generation unit 404 may comprise a first filtering sub-unit, a first processing sub-unit, and a first generation sub-unit, wherein

the first filtering sub-unit is configured to filter the product information in the product list according to the purchasing power index and the price indexes to obtain a first set of results;

the first processing sub-unit is configured to filter the first set of results according to the personalized labels and the product labels to obtain a second set of results; and

the first generation sub-unit is configured to generate the product recommendation list for the user according to the second set of results.

Alternatively, the first filtering sub-unit may particularly be configured to: compare the purchasing power index with the price indexes of the product information in the product list respectively; and if an absolute value of a difference between the purchasing power index and the price index is less than a first predetermined threshold, add corresponding product information to the first set of results.

Alternatively, the first processing sub-unit may particularly be configured to: calculate liking probabilities of the user on respective product labels according to the personalized labels; calculate liking probabilities of the user on respective product information in the first set of results according to the liking probabilities of the user on the respective product labels; calculate user liking degree scores of respective product information in the first set of results according to the liking probabilities and the recommendation scores of the user for the respective product information in the first set of results; and add the product information of which the user liking degree score exceeds a second predetermined threshold to the second set of results.

The first predetermined threshold and the second predetermined threshold may be set according to requirements in practical applications, which will not be described here in detail.

Alternatively, the first generation sub-unit may particularly be configured to: rank the product information in the second set of results according to the user liking degree scores to generate the product recommendation list for the user.

Second Manner: the product recommendation list generation unit 404 may comprise a second processing sub-unit, a second filtering sub-unit and a second generation sub-unit, wherein

the second processing sub-unit is configured to filter the product information in the product list according to the personalized labels and the product labels to obtain a third set of results;

the second filtering sub-unit is configured to filter the third set of results according to the purchasing power index and the price indexes to obtain a fourth set of results; and

the second generation sub-unit is configured to generate the product recommendation list for the user according to the fourth set of results.

Alternatively, the second processing sub-unit may particularly be configured to: calculate liking probabilities of the user on respective product labels according to the personalized labels; calculate liking probabilities of the user on respective product information in the product list according to the liking probabilities of the user on the respective product labels; calculate user liking degree scores of respective product information in the product list according to the liking probabilities and the recommendation scores of the user for the respective product information in the product list; and add the product information of which the user liking degree score exceeds a second predetermined threshold to the third set of results.

Alternatively, the second filtering sub-unit may particularly be configured to: compare the purchasing power index with the price indexes of the product information in the third set of results respectively; and if an absolute value of a difference between the purchasing power index and the price index is less than a first predetermined threshold, add corresponding product information into the fourth set of results.

Alternatively, the second generation sub-unit may particularly be configured to: rank the product information in the fourth set of results according to the user liking degree scores to generate the product recommendation list for the user.

The above particular implementation of generating a product recommendation list for the user may refer to the above method embodiment, and will not be described here in detail.

Particularly, the purchasing power index of the user may be calculated according to price indexes and weights of respective types of products which have been purchased by the user. That is,

the user information collection unit 403 may particularly be configured to: acquire price indexes and weights of respective types of products which have been purchased by the user; sum products of the price indexes and the weights of the respective types of products which have been purchased by the user to obtain a first value; and divide the first value by a sum of the weights of the respective types of products which have been purchased by the user to obtain the purchasing power index of the user. The formula is as follows.

$$purchasing\_power = \frac{{\sum }_{i = 1}^{n} weight ( i ) * price ( i )}{{\sum }_{i = 1}^{n} weight ( i )}$$

wherein purchasing_power is the purchasing power index of the user, Weight(i) is a weight of an i-th type of products, and price(i) is a price index of the i-th type of products.

Since prices of most of the products may be concentrated in a small interval, a logical distribution formula may be used for balancing in order to balance data distribution. That is,

the product information acquisition unit 403 may further be configured to perform a balance processing on the price indexes using the logical distribution formula to obtain balanced price indexes. For example, a particular calculation formula may be as follows.

$$price ( i ) \_dis = \frac{price ( i ) - u ( price )}{σ ( price )}$$

wherein, price(i)_dis is a balanced price index, u(price) is an average value of the price indexes, and σ(price) is a variance of the price indexes.

In this case, the product recommendation list generation unit 404 may particularly be configured to generate a product recommendation list for the user according to the purchasing power index, the personalized labels, the product labels, and the balanced price indexes, wherein the particular approach(es) of generating the product recommendation list may refer to the above description, and will not be described here in detail.

During particular implementation, the above various units may be implemented as independent entities, or may be combined randomly as the same entity or a number of entities. The particular implementation of the above various units may be known with reference to the above embodiments, and will not be described here in detail.

The apparatus for recommending product information may be integrated into a server.

Thus, the product information acquisition unit 401 in the apparatus for recommending product list according to the present embodiment may acquire a product list comprising product information of at least one product, wherein the product information comprises product names and price indexes and is associated with at least one product label; then the user information collection unit 403 calculates a purchasing power index of a user and acquiring personalized labels of the user; then the product recommendation list generation unit 404 generates a personalized product recommendation list for the user according to the purchasing power index, the personalized labels, the product labels, and the price indexes; and finally the recommendation unit 405 makes a recommendation to the user based on the product recommendation list. This solution can not only accurately recommend the product information to a user with corresponding requirements, but also better comply with users' requirements as the product recommendation list is generated according to the purchasing power and hobbies and interests of the user, thereby improving quality of the user's experience.

### Fifth Embodiment

Correspondingly, the embodiment of the present disclosure provides a communication system, comprising the apparatus for recommending product information according to any of the embodiments of the present disclosure. The apparatus for recommending product information may be known with reference to the fourth embodiment. For example, the particular description thereof may be as follows.

The apparatus for recommending product information is configured to acquire a product list comprising product information of at least one product from a server, wherein the product information comprises product names and price indexes and is associated with at least one product label; calculate a purchasing power index of a user and acquire personalized labels of the user, wherein the personalized labels are a set of product labels that the user likes; generate a product recommendation list for the user according to the purchasing power index, the personalized labels, the product labels, and the price indexes; and make a recommendation to the user based on the product recommendation list. The particular description may be known with reference to the above embodiments, and will not be described here in detail.

Further, the communication system may further comprise a user device, configured to receive the product recommendation list which is transmitted by the apparatus for recommending product information.

Since the communication system comprises the apparatus for recommending product information according to any of the embodiments of the present disclosure, the beneficial effects which can be implemented by the above apparatus for recommending product information can also be implemented, which will not be described here in detail.

### Sixth Embodiment

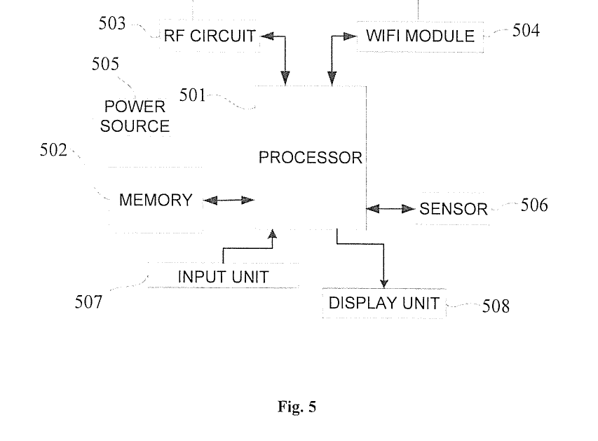

The embodiment of the present disclosure further provides a server, into which the apparatus for recommending product information according to the embodiment of the present disclosure may be integrated. As shown in FIG. 5, illustrated is a structure diagram of the server according to the embodiment of the present disclosure.

Particularly, the server may comprise components, for example, one or more processing cores, such as a processor 501, one or more computer readable storage media, such as a memory 502, a Radio Frequency (RF) circuit 503, a wireless communication module, such as a Bluetooth module and/or Wireless Fidelity (WiFi) module 504 etc. (the WiFi module 504 is used as an example in FIG. 5), a power source 505, a sensor 506, an input unit 507, and a display unit 508 etc. It can be understood by those skilled in the art that the structure of the server illustrated in FIG. 5 does not constitute limitations of the server. There may be more or less components than those illustrated in FIG. 5, or some components may be combined, or there may be different arrangements of the components.

The processor 501 is a control center of the server, which connects various parts of the whole server via various interfaces and lines, and implements various functions of the server and processes data by executing or performing software programs and/or modules stored in the memory 502 and invoking data stored in the memory 502, so as to monitor the whole server. Optionally, the processor 501 may comprise one or more processing cores. Preferably, the processor 501 may integrate an application processor and a modem processor, wherein the application processor primarily processes an operating system, a user interface, and an application program etc., and the modem processor primarily processes wireless communication. It can be understood that the above modem processor may also not be integrated into the processor 501.

The memory 502 may be used to store software programs and modules, and the processor 501 implements various function applications and processes data by executing the software programs and modules stored in the memory 502. The memory 502 may primarily comprise a program storage area and a data storage area, wherein the program storage area may store the operating system, application programs required for at least one function (for example, voice play function, image play function etc.); and the data storage area may store data which is created according to the use of the server etc. Further, the memory 502 may comprise a cache, and may also comprise a nonvolatile memory, such as at least one disc memory, a flash, or other volatile solid-state memories. Correspondingly, the memory 502 may further comprise a memory controller to provide access to the memory 502 by the processor 501.

The RF circuit 503 may be used to receive and transmit signals in the process of information reception and transmission. Particularly, the RF circuit 503 receives downlink information from the base station, and transmits the information to one or more processors 501 for processing; and further transmits uplink data to the base station. In generally, the RF circuit 503 comprises but is not limited to an antenna, at least one amplifier, a tuner, one or more oscillators, a Subscriber Identification Module (SIM) card, a transceiver, a coupler, a Low Noise Amplifier (LNA), a duplexer etc. Further, the RF circuit 503 may further communicate with networks and other devices through wireless communication. The wireless communication may be implemented using any communication standard or protocol, which comprises but is not limited to Global System of Mobile communication (GSM), General Packet Radio Service (GPRS), Code Division Multiple Access (CDMA), Wideband Code Division Multiple Access (WCDMA), Long Term Evolution (LTE), emails, Short Messaging Service (SMS) etc.

WiFi belongs to short-distance wireless transmission technology, and the server receives and transmits emails and accesses streaming media etc through the WiFi module 504, which may provide wireless access to broadband internet. Although the WiFi module 504 is illustrated in FIG. 5, it can be understood that the WiFi module 504 is not necessary for the server, and may be omitted as required without departing from the scope of the substance of the present disclosure.

The server further comprises a power source 505 (such as a battery) for supplying power to various components. Preferably, the power source may be logically connected to the processor 501 through a power source management system, so as to achieve functions such as charging management, discharging management, and power consumption management etc. through the power source management system. The power source 505 may further comprise any component such as one or more direct or alternate current power sources, a recharging system, a power source fault detection circuit, a power source converter or an inverter, a power source state indictor etc.

The server may further comprise at least one sensor 506, for example, an optical sensor, a motion sensor, and other sensors. The server may also be configured with other sensors such as a gyroscope, a barometer, a humidometer, a thermometer, an infrared sensor etc., which will not be described here in detail.

The server may further comprise an input unit 507, which may be configured to receive input digit or character information, and generate keyboard, mouse, joystick, optical or trackball signal input related to user setting and functional control. Particularly, in a particular embodiment, the input unit 507 may comprise a touch-sensitive surface and other input devices. The touch-sensitive surface is also referred to as a touch display or a touch panel, which may be configured to collect touch operations implemented by a user thereon or nearby (for example, operations implemented by a user with any suitable object or accessory such as a finger, a stylus etc. on the touch-sensitive surface or near the touch-sensitive surface), and drive corresponding connected apparatuses according to predetermined programs. Optionally, the touch-sensitive surface may comprise two parts, i.e., a touch detection apparatus and a touch controller. The touch detection apparatus detects an orientation of touch from a user, detects a signal generated by the touch operation, and transmits the signal to the touch controller. The touch controller receives the touch information from the touch detection apparatus, converts the touch information into coordinates of touch points, transmits the coordinates to the processor 501, and can receive and execute a command transmitted by the processor 501. In addition, many types of touch-sensitive surfaces may be achieved, for example, resistive, capacitive, infrared, and surface acoustic wave touch-sensitive surfaces etc. In addition to the touch-sensitive surface, the input unit 507 may further comprise other input devices. Particularly, other input devices may comprise but are not limited to one or more of a physical keyboard, functional keys (such as a volume control key, a switch key etc.), a trackball, a mouse, a joystick etc.

The server may further comprise a display unit 508, which may be configured to display information input by a user and information provided to the user, and various graphic user interfaces of the server. These graphic user interfaces may be formed by graphics, texts, icons, videos, or any combination thereof. The display unit 508 may comprise a display panel. Optionally, the display panel may be configured in a manner of Liquid Crystal Display (LCD), Organic Light-Emitting Diode (OLED) etc. Further, the touch-sensitive surface may cover the display panel. After the touch-sensitive surface detects a touch operation thereon or nearby, the touch-sensitive surface transmits the touch operation to the processor 501 to determine a type of the touch event, and then the processor 501 provides corresponding visual output on the display panel according to the type of the touch event. Although the touch-sensitive surface and the display panel achieve input and output functions as two independent components in FIG. 5, in some embodiments, the touch-sensitive surface and the display panel may be integrated to achieve the input and output functions.

Although not shown, the server may further comprise a camera, a Bluetooth module etc., which will not be described here in detail. Particularly, in an embodiment, the processor 501 in the server may load executable files corresponding to processes of one or more application programs into the memory 502 according to the following instructions, and the application programs stored in the memory 502 are executed by the processor 501 to implement various functions as follows:

acquiring a product list comprising product information of at least one product from a server, wherein the product information comprises product names and price indexes and is associated with at least one product label;

calculating a purchasing power index of a user and acquiring personalized labels of the user, wherein the personalized labels are a set of product labels that the user likes;

generating a product recommendation list for the user according to the purchasing power index, the personalized labels, the product labels, and the price indexes; and

making a recommendation to the user based on the product recommendation list.

The step of “generating a product recommendation list for the user according to the purchasing power index, the personalized labels, the product labels, and the price indexes” may be implemented in any of the following manners:

First Manner:

(1) filtering the product information in the product list according to the purchasing power index and the price indexes to obtain a first set of results. For example, the process may particularly comprise:

comparing the purchasing power index with the price indexes of the product information in the product list respectively; and if an absolute value of a difference between the purchasing power index and the price index is less than a first predetermined threshold, adding corresponding product information into the first set of results.

The first predetermined threshold may be set according to requirements in practical applications, and will not be described here in detail.

(2) filtering the first set of results according to the personalized labels and the product labels to obtain a second set of results. For example, the process may particularly comprise:

respectively calculating liking probabilities of the user on respective product labels according to the personalized labels; calculating liking probabilities of the user on respective product information in the first set of results according to the liking probabilities of the user on the respective product labels; calculating user liking degree scores of respective product information in the first set of results according to the liking probabilities and the recommendation scores (which are included in the product information) of the user for the respective product information in the first set of results; and adding the product information of which the user liking degree score exceeds a second predetermined threshold to the second set of results.

The second predetermined threshold may be set according to requirements in practical applications, and will not be described here in detail.

(3) generating the product recommendation list for the user according to the second set of results. For example, the process may particularly comprise:

ranking the product information in the second set of results according to the user liking degree scores to generate the product recommendation list for the user.

Second Manner:

(1) filtering the product information in the product list according to the personalized labels and the product labels to obtain a third set of results. For example, the process may particularly comprise:

respectively calculating liking probabilities of the user on respective product labels according to the personalized labels; calculating liking probabilities of the user on respective product information in the product list according to the liking probabilities of the user on the respective product labels; calculating user liking degree scores of respective product information in the product list according to the liking probabilities and the recommendation scores (which are included in the product information) of the user for the respective product information in the product list; and adding the product information of which the user liking degree score exceeds a second predetermined threshold to the third set of results.

The second predetermined threshold may be set according to requirements in practical applications, and will not be described here in detail.

(2) filtering the third set of results according to the purchasing power index and the price indexes to obtain a fourth set of results. For example, the process may particularly comprise:

comparing the purchasing power index with the price indexes of the product information in the third set of results respectively; and if an absolute value of a difference between the purchasing power index and the price index is less than a first predetermined threshold, adding corresponding product information into the fourth set of results.

The first predetermined threshold may be set according to requirements in practical applications, and will not be described here in detail.

(3) generating the product recommendation list for the user according to the fourth set of results. For example, the process may particularly comprise:

ranking the product information in the fourth set of results according to the user liking degree scores to generate the product recommendation list for the user.

It should be illustrated that after the product list is acquired, a logical distribution formula is further used for balancing the price indexes to obtain balanced price indexes; if a balancing process has been implemented on the price indexes using the logical distribution formula, the price indexes used in the step may be balanced price indexes, i.e., “generating a product recommendation list for the user according to the purchasing power index, the personalized labels, the product labels, and the price indexes” may particularly comprise:

generating the product recommendation list for the user according to the purchasing power index, the personalized labels, the product labels, and the balanced price indexes.

Alternatively, calculating the purchasing power index of the user may comprise:

acquiring price indexes and weights of respective types of products which have been purchased by the user, summing products of the price indexes and the weights of the respective types of products which have been purchased by the user to obtain a first value, and dividing the first value by a sum of the weights of the respective types of products which have been purchased by the user to obtain the purchasing power index of the user.

The particular implementation of the above respective steps may be known with reference to the above embodiments, and will not be described here in detail.

Thus, the server according to the present embodiment may acquire a product list comprising product information of at least one product, wherein the product information comprises product names and price indexes and is associated with at least one product label; calculate a purchasing power index of a user and acquire personalized labels of the user; generate a personalized product recommendation list for the user according to the purchasing power index, the personalized labels, the product labels, and the price indexes; and make a recommendation to the user based on the product recommendation list. This solution can not only accurately recommend the product information to a user with corresponding requirements, but also better comply with users' requirements as the product recommendation list is generated according to the purchasing power and hobbies and interests of the user, thereby improving quality of the user's experience.

It can be understood by an ordinary skilled in the art that all or a part of steps in the various methods according to the above embodiments may be implemented by a program instructing related hardware, which may be stored in a computer readable storage medium. The storage medium may comprise a Read Only Memory (ROM), a Random Access Memory (RAM), a disk or a disc etc.

The method, apparatus and system for recommending product information according to the embodiments of the present disclosure have been described in detail above. Further, the principle and implementations of the present disclosure are set forth herein by way of particular examples. The description of the above embodiments is merely used to facilitate understanding of the method according to the present disclosure and the core idea thereof. Further, those skilled in the art can make changes according to the idea of the present disclosure within the scope of the particular implementations and applications. In conclusion, the content of the specification should not be construed as limiting the present disclosure.

It is claimed:

1. A method of recommending product information, comprising the steps of:
acquiring a product list comprising product information on at least one product from a server, wherein the product information comprises product names and price indexes and is associated with at least one product label;
calculating a purchasing power index of a user and acquiring personalized labels of the user, wherein the personalized labels are a set of product labels that the user likes;
generating a product recommendation list for the user according to the purchasing power index, the personalized labels, the product labels, and the price indexes, wherein product information in the product recommendation list is selected from the product list; and
making a recommendation to the user based on the product recommendation list.

2. The method according to claim 1, wherein the step of generating the product recommendation list for the user according to the purchasing power index, the personalized labels, the product labels, and the price indexes comprises the steps of:
filtering the product information in the product list according to the purchasing power index and the price indexes to obtain a first set of results;
filtering the first set of results according to the personalized labels and the product labels to obtain a second set of results; and
generating the product recommendation list for the user according to the second set of results.

3. The method according to claim 2, wherein the step of filtering the product information in the product list according to the purchasing power index and the price indexes to obtain the first set of results comprises the steps of:
comparing the purchasing power index with the price indexes of the product information in the product list respectively; and
if an absolute value of a difference between the purchasing power index and the price index is less than a first predetermined threshold, adding the product information which comprises the price index to the first set of results.

4. The method according to claim 3, wherein the production information further comprises recommendation scores, and wherein the step of filtering the first set of results according to the personalized labels and the product labels to obtain the second set of results comprises the steps of:
calculating liking probabilities of the user on respective product labels according to the personalized labels;
calculating liking probabilities of the user on respective product information in the first set of results according to the liking probabilities of the user on the respective product labels;
calculating user liking degree scores of respective product information in the first set of results according to the liking probabilities and the recommendation scores of the user for the respective product information in the first set of results; and
adding the product information of which the user liking degree score exceeds a second predetermined threshold to the second set of results.

5. The method according to claim 4, the step of wherein generating the product recommendation list for the user according to the second set of results comprises the step of:
ranking the product information in the second set of results according to the user liking degree scores to generate the product recommendation list for the user.

6. The method according to claim 1, wherein the step of generating the product recommendation list for the user according to the purchasing power index, the personalized labels, the product labels, and the price indexes comprises the steps of:
filtering the product information in the product list according to the personalized labels and the product labels to obtain a third set of results;
filtering the third set of results according to the purchasing power index and the price indexes to obtain a fourth set of results; and
generating the product recommendation list for the user according to the fourth set of results.

7. The method according to claim 6, wherein the product information further comprises recommendation scores, and wherein the step of filtering the product information in the product list according to the personalized labels and the product labels to obtain the third set of results comprises the steps of:
calculating liking probabilities of the user on respective product labels according to the personalized labels;
calculating liking probabilities of the user on respective product information in the product list according to the liking probabilities of the user on the respective product labels;
calculating user liking degree scores of respective product information in the product list according to the liking probabilities and the recommendation scores of the user for the respective product information in the product list; and
adding the product information of which the user liking degree score exceeds a second predetermined threshold to the third set of results.

8. The method according to claim 7, wherein the step of filtering the third set of results according to the purchasing power index and the price indexes to obtain the fourth set of results comprises the steps of:
comparing the purchasing power index with the price indexes of the product information in the third set of results respectively; and
if an absolute value of a difference between the purchasing power index and the price index is less than a first predetermined threshold, adding the product information which comprises the price index to the fourth set of results.

9. The method according to claim 7, wherein the step of generating the product recommendation list for the user according to the fourth set of results comprises the step of:
ranking the product information in the fourth set of results according to the user liking degree scores to generate the product recommendation list for the user.

10. The method according to claim 1, wherein the step of calculating the purchasing power index of the user comprises the steps of:
acquiring price indexes and weights of respective types of products which have been purchased by the user;
summing products of the price indexes and weights of the respective types of products which have been purchased by the user to obtain a first value; and
dividing the first value by a sum of the weights of the respective types of products which have been purchased by the user to obtain the purchasing power index of the user.

11. The method according to claim 1, wherein after acquiring the product list, the method further comprises the steps of:
performing a balance processing on the price indexes using a logical distribution formula to obtain balanced price indexes; and
generating the product recommendation list for the user according to the purchasing power index, the personalized labels, the product labels, and the balanced price indexes.

12. An apparatus for recommending product information, comprising:
a product information acquisition unit, configured to acquire a product list comprising product information on at least one product from a server, wherein the product information comprises product names and price indexes and is associated with at least one product label;
a user information collection unit, configured to calculate a purchasing power index of a user and acquire personalized labels of the user, wherein the personalized labels are a set of product labels that the user likes;
a product recommendation list generation unit, configured to generate a product recommendation list for the user according to the purchasing power index, the personalized labels, the product labels, and the price indexes, wherein product information in the product recommendation list is selected from the product list; and
a recommendation unit configured to make a recommendation to the user based on the product recommendation list.

13. The apparatus according to claim 12, wherein the product recommendation list generation unit comprises a first filtering sub-unit, a first processing sub-unit, and a first generation sub-unit, wherein
the first filtering sub-unit is configured to filter the product information in the product list according to the purchasing power index and the price indexes to obtain a first set of results;
the first processing sub-unit is configured to filter the first set of results according to the personalized labels and the product labels to obtain a second set of results; and
the first generation sub-unit is configured to generate the product recommendation list for the user according to the second set of results.

14. The apparatus according to claim 13, wherein the first filtering sub-unit is further configured to:
compare the purchasing power index with the price indexes of the product information in the product list respectively; and if an absolute value of a difference between the purchasing power index and the price index is less than a first predetermined threshold, add the product information which comprises the price index to the first set of results.

15. The apparatus according to claim 14, wherein the production information further comprises recommendation scores, and the first processing sub-unit is further configured to:
calculate liking probabilities of the user on respective product labels according to the personalized labels; calculate liking probabilities of the user on respective product information in the first set of results according to the liking probabilities of the user on the respective product labels; calculate user liking degree scores of respective product information in the first set of results according to the liking probabilities and the recommendation scores of the user for the respective product information in the first set of results; and add the product information of which the user liking degree score exceeds a second predetermined threshold to the second set of results.

16. The apparatus according to claim 15, wherein the first generation sub-unit is further configured to:
rank the product information in the second set of results according to the user liking degree scores to generate the product recommendation list for the user.

17. The apparatus according to claim 12, wherein the product recommendation list generation unit comprises a second processing sub-unit, a second filtering sub-unit and a second generation sub-unit, and wherein
the second processing sub-unit is configured to filter the product information in the product list according to the personalized labels and the product labels to obtain a third set of results;
the second filtering sub-unit is configured to filter the third set of results according to the purchasing power index and the price indexes to obtain a fourth set of results; and
the second generation sub-unit is configured to generate the product recommendation list for the user according to the fourth set of results.

18. The apparatus according to claim 17, wherein the product information further comprises recommendation scores, and the second processing sub-unit is further configured to:
calculate liking probabilities of the user on respective product labels according to the personalized labels; calculate liking probabilities of the user on respective product information in the product list according to the liking probabilities of the user on the respective product labels; calculate user liking degree scores of respective product information in the product list according to the liking probabilities and the recommendation scores of the user for the respective product information in the product list; and add the product information of which the user liking degree score exceeds a second predetermined threshold to the third set of results.

19. The apparatus according to claim 18, wherein the second filtering sub-unit is further configured to:
compare the purchasing power index with the price indexes of the product information in the third set of results respectively; and if an absolute value of a difference between the purchasing power index and the price index is less than a first predetermined threshold, add the product information which comprises the price index to the fourth set of results.

20. The apparatus according to claim 18, wherein the second generation sub-unit is further configured to:
rank the product information in the fourth set of results according to the user liking degree scores to generate the product recommendation list for the user.

21. The apparatus according to claim 12, wherein the user information collection unit is further configured to:
acquire price indexes and weights of respective types of products which have been purchased by the user; sum products of the price indexes and weights of the respective types of products which have been purchased by the user to obtain a first value; and divide the first value by a sum of the weights of the respective types of products which have been purchased by the user to obtain the purchasing power index of the user.

22. The apparatus according to claim 12, wherein
the product information acquisition unit is further configured to perform a balance processing on the price indexes using a logical distribution formula to obtain balanced price indexes; and
the product recommendation list generation unit is further configured to generate the product recommendation list for the user according to the purchasing power index, the personalized labels, the product labels, and the balanced price indexes.

23. A communication system, comprising:
a server in which a product list is stored; and
a product information acquisition unit, configured to acquire a product list comprising product information on at least one product from a server, wherein the product information comprises product names and price indexes and is associated with at least one product label;
a user information collection unit, configured to calculate a purchasing power index of a user and acquire personalized labels of the user, wherein the personalized labels are a set of product labels that the user likes;
a product recommendation list generation unit, configured to generate a product recommendation list for the user according to the purchasing power index, the personalized labels, the product labels, and the price indexes, wherein product information in the product recommendation list is selected from the product list; and
a recommendation unit configured to make a recommendation to the user based on the product recommendation list.
